(19) United States
(12) Patent Application Publication
(10) Pub. No.: US 2008/0017631 A1
(43) Pub. Date: Jan. 24, 2008

(54) Hot-Air Blower Having Artificial Intelligence

(76) Inventor: Woo Young Park, Seoul (KR)

Correspondence Address: CANTOR COLBURN, LLP, 55 GRIFFIN ROAD SOUTH, BLOOMFIELD, CT, 06002, US

(21) Appl. No.: 11/570,690

(22) PCT Filed: Jan. 13, 2005
(86) PCT No.: PCT/KR05/00119

§ 371 Date: Jun. 28, 2007

(30) Foreign Application Priority Data
Jun. 16, 2004 (KR) 20-2004-0016891
Oct. 18, 2004 (KR) 10-2004-0083182

(51) Int. Cl. F24H 3/02; F24H 9/20; H05B 1/02

(52) U.S. Cl. 219/494; 392/364; 415/47

(57) ABSTRACT

Disclosed herein is a hot-air blower for supplying hot air in order to prevent freeze-rupture of a water pipe or the like. The hot-air blower is installed in the interior of a room. According to the present invention, at the state where the electric power is continuously supplied, the heater and the fan are intermittently operated in the operating state and also even at the interrupted state of operation. Therefore, the hot air can be efficiently supplied into the interior of a room to thereby prevent the freeze-rupture of the water pipe or the like. Accordingly, as compared with the conventional hot-air blower, which is operated over the whole wintertime to supply hot air, the electrical consumption can be considerably reduced, thereby providing a significant economical benefit. Furthermore, in the case where it is installed in the ceiling of the interior of a room, since the temperature of the interior of the room including the floor thereof can be precisely detected and hot air is supplied accordingly, the freeze-rupture of a water pipe installed in the floor can be prevented, dissimilar to the conventional technique.

### TECHNICAL FIELD

The present invention relates to a hot-air blower. In particular, the invention relates to a power saving hot-air blower, which can be installed in the interior of a room having a poor heating facility such as a rest room and supply hot air in order to prevent freeze-rupture of a water pipe or the like.

### BACKGROUND ART

Generally, in the building having an inadequate heating facility or a poor insulation, for example, in the office having a sprinkler for fire-protection or in the toilet in the park or resort area, reportedly freeze-rupture of the water pipe and plumbing occurs frequently in the cold wintertime. Therefore, a hot-air blower for supplying hot air to the interior of a room such as the toilet is installed in order to prevent the freeze-rupture of the water pipe in the cold wintertime.

However, the conventional hot-air blower is structured so as to measure the interior temperature and supply hot air for prevention of freeze-rupture only while the blower is operated. Therefore, when it is not operated due to the administrator's negligence of duty, or the power is interrupted and restored, or the operation is not initiated in the first place, the conventional blower can hardly carry out the function of supplying hot air for prevention of freeze-rupture of the water pipe. Accordingly, the conventional hot-air blower must be operated continuously over the whole wintertime, and thus consume excessive electric power. As such, the conventional technique is not economically efficient.

In particular, since the hot-air blower, which is installed in the ceiling of the interior of a room, is distant from the floor of the room, the interior temperature near the floor cannot be appropriately detected. That is, in the case where the hot-air blower is installed in the ceiling, the temperature of the ceiling is lower than that of the floor and thus the blower is not operated even when the interior of the room is cold. Therefore, due to a big difference in the interior temperature, the effect of the hot air does not reach the water pipe installed along the floor, which suffers frequently the freeze-rupture thereof.

### DISCLOSURE OF INVENTION

Technical Problem

The present invention has been made in order to solve the above problems in the art, and it is an object of the invention to provide a power saving hot-air blower, in which the interior temperature is precisely detected during its operation and even at the interrupted state of operation and accordingly hot air can be supplied to thereby prevent freeze-rupture of the water pipe or the like, and also after the operation thereof is interrupted, the interior air is suctioned in order to reduce the temperature difference between the ceiling and the floor, thereby improving the precision of the temperature.

Technical Solution

In order to accomplish the above object, according to one aspect of the invention, there is provided a hot-air blower for supplying hot air in order to prevent freeze-rupture of a water pipe or the like. The hot-air blower is installed in the interior of a room. The hot-air blower of the invention comprises: a) a case having a desired size of accommodation space, the case being installed in the ceiling or the wall of the interior of a room such that one side face thereof is exposed to the outside; b) a heater installed inside the case and adapted to generate heat for prevention of freeze-rupture of the water pipe and the like; c) a fan installed at the proximity of the heater inside the case, wherein, while the heater is operated, the fan forms an air circulation cycle passing the heater and the interior of the room to thereby supply hot-air into the interior of the room, and wherein the fan is re-operated independently to in-flow the interior air inside the case even after the operation of the heater is interrupted; d) a temperature sensor installed inside the case and adapted to detect the temperature of the interior air flowing into the case through the fan, the detected temperature being used as data to determine whether or not the heater and the fan are to be operated; e) a controller installed inside the case and adapted to form an electrical circuit with the heater, the fan, and the temperature sensor, wherein during the operation the controller controls the on/off operation of the heater and the fan according to the interior temperature detected by the temperature sensor, and wherein, the controller controls the post-interruption operation of the heater such that the temperature sensor detects the interior temperature and re-operation of the heater and the fan is carried out; and f) a power supply installed inside the case and adapted to supply an electric power applied from outside to the heater, the fan, the temperature sensor, and the controller.

Preferably, during the operation, the controller controls the operation of the heater and the fan such that the interior temperature detected by the temperature sensor is compared with a certain first pre-set temperature and the interior temperature is maintained equal to the first pre-set temperature. During the interruption of operation, preferably, the controller controls the operation of the heater and the fan such that the interior temperature detected by the temperature sensor is compared with a second and third pre-set temperature established so as to have a temperature difference and the interior temperature remains between the second and third pre-set temperature.

In addition, preferably, the controller controls the re-operation of the fan such that it is intermittently re-operated after the operation of the heater has been interrupted and a certain period of time has been passed.

Advantageous Effects

According to the present invention, at the state where the electric power is continuously supplied, the heater and the fan are intermittently operated in the operating state and also even at the interrupted state of operation. Therefore, the hot air can be efficiently supplied into the interior of a room to thereby prevent the freeze-rupture of the water pipe or the like. Accordingly, as compared with the conventional hot-air blower, which is operated over the whole wintertime to supply hot air, the electrical consumption can be considerably reduced, thereby providing a significant economical benefit. Furthermore, in the case where it is installed in the ceiling of the interior of a room, since the temperature of the interior of the room including the floor thereof can be precisely detected and hot air is supplied accordingly, the freeze-rupture of a water pipe installed in the floor can be prevented, dissimilar to the conventional technique.

### BRIEF DESCRIPTION OF THE DRAWINGS

Further objects and advantages of the invention can be more fully understood from the following detailed description taken in conjunction with the accompanying drawings, in which:

FIG. 1 illustrates a hot-air blower according to one embodiment of the invention, which is installed in the ceiling of an interior room such as a rest room;

FIG. 2 is a circuit diagram of the hot-air blower of the invention; and

FIG. 3 is a flow chart showing the operation of the hot-air blower of the invention.

### BEST MODE FOR CARRYING OUT THE INVENTION

The preferred embodiments of the present invention will be hereafter described in detail with reference to the accompanying drawings.

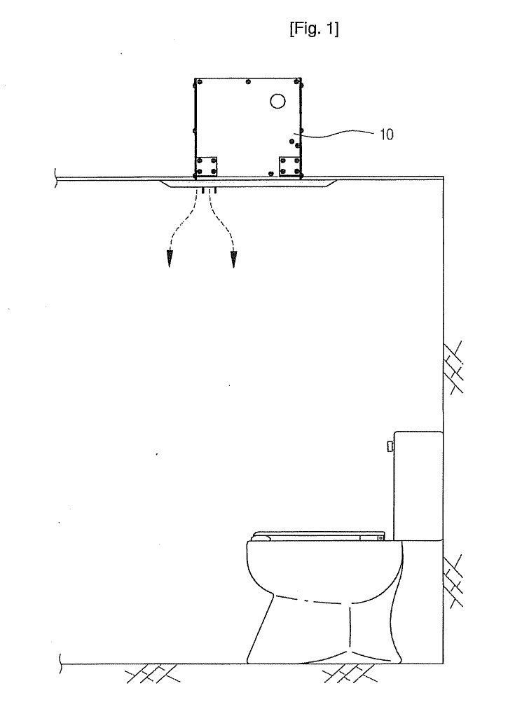

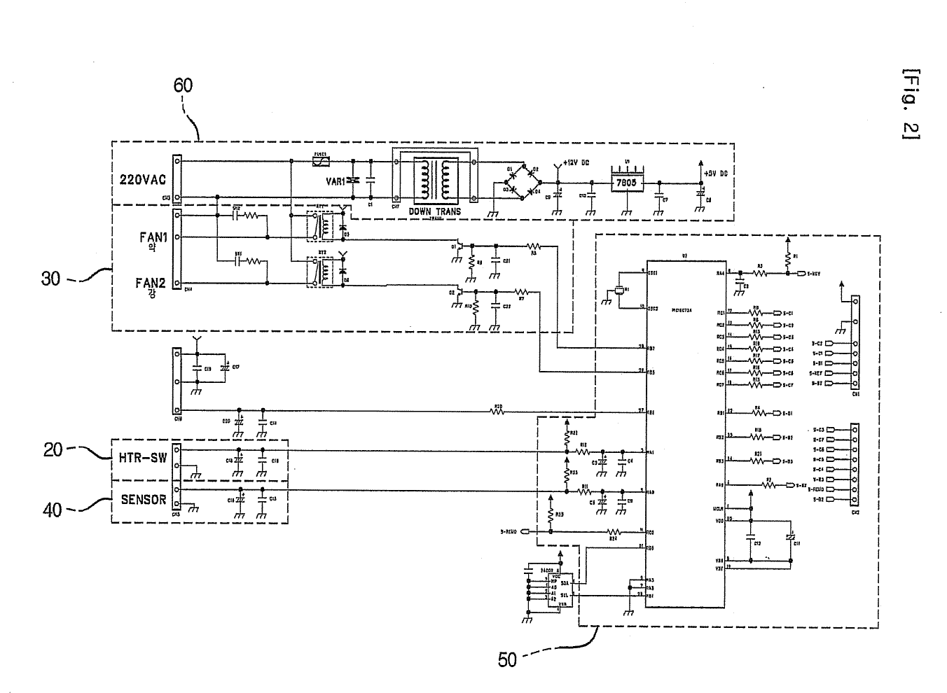

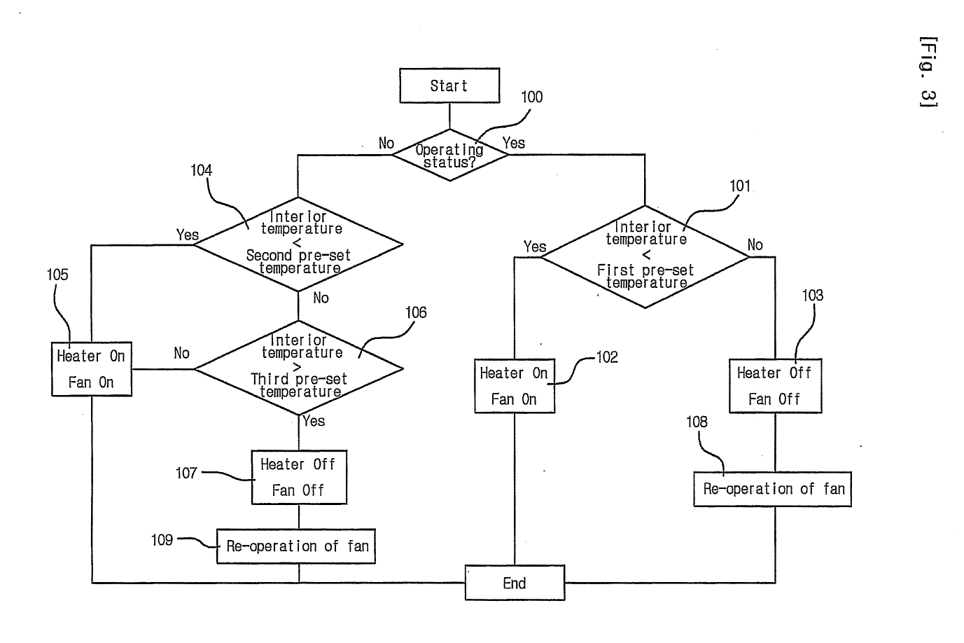

FIG. 1 illustrates a hot-air blower according to one embodiment of the invention, which is installed in the ceiling of an interior room such as a rest room. FIG. 2 is a circuit diagram of the hot-air blower of the invention. FIG. 3 is a flow chart showing the operation of the hot-air blower of the invention.

As illustrated in FIGS. 1 and 2, the hot-air blower of the invention is provided with a case 100 having a certain desired shape. The case 100 is designed such that it can be installed inside a room and has an accommodation room provided thereinside. The case 100 of the hot-air blower is structured such that it can be installed in the ceiling or the wall of the interior of a room such as a rest room and one side thereof is exposed to the outside of the room. Although not illustrated, the exposed side of the case 100 is provided with an opening for communicating between the inside and the outside of the case 100.

The case 10 is provided with a heater 20 installed in the inside thereof. The heater 20 is provided in order to generate heat for prevention of freeze-rupture of a tap-water pipe or the like. The heater 20 is installed preferably inside the case 10 and near the opening thereof. The heater 20 employs a heating coil to generate heat, which is well known and thus of which details will not be described here.

Inside the case 10 a fan 30 is installed at the proximity of the heater 20. Although not illustrated, the fan 30 is rotated by means of a drive motor. Therefore, while the heater 20 is operated, an air circulation cycle is formed through the case 10 and the interior of a room to thereby supply hot air to the interior of the room. The air circulation cycle formed by the fan 30 is established through the opening of the case 10.

In addition, the fan 30 is re-operated independently after the operation of the heater 20 is stopped, so that it serves to introduce interior air into the inside of the case 10. The re-operation of the fan 30 is controlled by a controller, which will be hereinafter described. The time period for the re-operation of the fan after the interruption of the heater 20 is arbitrarily pre-established, when required. For example, the re-operating time of the fan 30 can be shortened or lengthened depending on the fluctuating weather of wintertime. Furthermore, the re-operating time of the fan 30 is established such that the interior air can be in-flown adequately to the inside of the case 10. In the case where the hot-air blower is installed in the ceiling of a room, the re-operating time is set preferably such that the air staying near the floor of the room can be introduced adequately. In this case, it is understood to those skilled in the art that the time period can be established depending on the distance between the ceiling and the floor of the room.

once the fan 30 is re-operated after the interruption of the heater 20, the interior temperature of a room can be measured with precision. Therefore, the supply of hot air can be efficiently carried out in order to prevent the freeze-fracture of the water pipe and the like. It is therefore understood that the prior art problems caused due to the installation of a hot-air blower in the ceiling can be appropriately compensated.

The case 10 is provided with a temperature sensor 40 installed inside thereof. The temperature sensor 40 is used to detect the interior temperature of the room, which is served as data in order to determine whether or not the heater 20 and the fan 30 are to be operated. The temperature is measured through the interior air flowing into the case 10 through the fan 30.

The case 10 is provided with a controller 50 installed inside of the case. The controller 50 forms an electrical circuit with the heater 20, the fan 30 and the temperature sensor 40, and the electrical circuit is installed inside the case 10. The controller 50 functions to control the operation of the heater 20 and the fan 30, depending on the interior temperature, which is detected by the temperature sensor 40.

That is, when the blower of the invention is operated (turned on) by the power supply, the controller 50 compares a first pre-set temperature with the interior temperature detected by the temperature sensor 40, and controls the operation of the heater 20 and the fan 30 such that the interior temperature of the room can be maintained to the first pre-set temperature. Also, when its operation is interrupted, the controller 50 is operated in such a manner that the interior temperature detected by the temperature sensor 40 is compared with a second and third pre-set temperatures, which has a certain temperature difference therebetween, and is maintained between the second and third pre-set temperatures by controlling the operation of the heater 20 and the fan 30. Here, the operating state means that, while the electric power is supplied, the operating on/off switch connected with the controller 50 is turned on by the user, i.e., a normal operation (on) state. The interruption of the operation means that while the electric power is supplied, the operating on/off switch is turned off by the user, i.e., a normal interruption of operation.

Furthermore, as described above, the controller 50 controls the re-operation of the fan 30 such that the temperature sensor 40 can detect the interior temperature after the operation of the heater 20 is interrupted. The controller 50 is configured in order for the temperature sensor 40 to measure the interior temperature precisely, in such a manner that the fan is intermittently re-operated for a certain period of time after the operation of the heater 20 is interrupted and then a certain time is passed.

Although not illustrated, at one face of the case 10 facing the outside thereof is installed an operating unit, which indicates the interior temperature detected by the temperature sensor 40 and also is used for inputting the pre-set temperatures and times to control the operation of the heater 20 and the fan 30. The controller 50 is configured to control the operation of the heater 20 and the fan 30 according to the pre-set temperatures and times, which are input through the operating unit.

Inside the case is installed a power supply 60 for supplying an electric power applied from the external to the heater 20, the fan 30, the temperature sensor 40 and the controller 50.

As illustrated in FIG. 3, therefore, when an electric power is continuously supplied through the power supply 60 and the on/off switch connected with the controller 50 is turned on by the user, a normal operating state is maintained (step 100). At this state, if the interior temperature detected through the temperature sensor 40 is determined as being less than the first pre-set temperature established in the controller 50 (step 101), the controller 50 orders so as to operate the heater 20 and the fan 30, thereby supplying hot-air into the interior of the room for the prevention of freeze-rupture of a water pipe or the like (step 102). In addition, if the interior temperature detected by the temperature sensor 40 is determined by the controller 50 as being above the first pre-set temperature (step 101), the controller 50 commands so as to interrupt the operation of the heater 20 and the fan 30, thereby stopping the supply of hot-air to the interior of the room.

For example, if the first pre-set temperature is set to 7° C., the controller 50 controls the operation of the heater 20 and the fan 30 such that the interior temperature detected by the temperature sensor 40 is maintained to 7° C. to thereby prevent the freeze-failure of the water pipe and the like.

When the operation of the heater 20 is interrupted and a certain period of time is passed, the controller 50 orders such that only the fan 30 is re-operated (step 108). After the fan 30 is operated for the pre-determined period of time preestablished in the controller 50, it stops its operation again according to the command of the controller 50. While the fan 30 is re-operated, the interior air is in-flown into the inside of the case 10 and the temperature sensor 40 detects the interior temperature from the interior air flowing into the case 10. As shown in table 1, this course of action may be carried out several times intermittently at certain intervals, which is pre-set in the controller 50. As the result of detecting the interior temperature, when the interior temperature is below the first pre-set temperature, the controller 50 operates the heater 20 and the fan 30 to thereby supply hot air into the interior of the room.

TABLE 1

| | Fan On | Fan Off | Fan On | Fan Off | Fan On | Fan Off | Fan On | Stand-by |
|---|---|---|---|---|---|---|---|---|
| After the | 2 min | 6 min | 25 sec | 12 min | 25 sec | 24 min | 25 sec | |
| heater is | 25 sec | | | | | | | |
| interrupted | | | | | | | | |
| and a | | | | | | | | |
| certain time | | | | | | | | |
| is passed | | | | | | | | |

For example, as shown in the table 1, after the operation of the heater 20 is interrupted and a certain time is passed, the fan is re-operated for 2 minutes 25 seconds to thereby introduce the interior air into the inside of the case 10. While the fan is re-operated for 2 minutes 25 seconds, the temperature sensor 40 detects the interior temperature from the interior air flowing into the case 10. As the result of the detection, if the controller 50 determines that the interior temperature is consistent with the first pre-set temperature, the fan 30 is not operated for 6 minutes. Thereafter, the controller 50 is operated such that the fan 30 is re-operated for 25 seconds, interrupted for 12 minutes, re-operated for 25 seconds, interrupted for 24 minutes, again re-operated for 25 seconds, and interrupted, etc., thereby enabling the precise detection of the interior temperature through the temperature sensor 40. While the fan 30 is re-operated, if the controller 50 determines that the interior temperature is lower than the first pre-set temperature, the operation of the heater 20 and the fan 30 is resumed to thereby supply hot-air to the interior of the room. These courses of action are repeated by the controller 50, and thus the prevention of freeze-rupture of the water pipe and the like, which are installed in the interior of a room such as a rest room, can be efficiently achieved.

On the other hand, at the state of interruption of operation where the electric power is continuously supplied through the power supply 60 and the on/off switch connected with the controller 50 is turned off by the user (step 100), if the interior temperature detected by the temperature sensor 40 is determined as being lower than the second pre-set temperature established in the controller 50 (step 104), the controller 50 orders the heater 20 and the fan 30 to be operated to supply hot-air to the interior of the room (step 105), thereby preventing freeze-fracture of the water pipe an the like. At this state, if the interior temperature detected by the temperature sensor 40 is determined as being higher than the third pre-set temperature established in the controller 50 (step 106), the controller 50 commands so as to stop the operation of the heater 20 and the fan 30 to thereby stop supplying hot-air into the interior of the room (step 107).

That is, if the second pre-set temperature is set to 8 and the third pre-set temperature is set to 12° C. in the controller 50, the controller 50 controls the operation of the heater 20 and the fan 30 such that the interior temperature is held within a range between 8° C. and 12° C., thereby preventing freeze-rupture of the water pipe and the like.

After the operation of the heater 20 is interrupted and a certain period of time is passed, the controller 50 orders only the fan 30 to be re-operated (step 109). The fan 30 is re-operated for the pre-determined period of time, which is set in the controller 50. After the operation for the pre-determined period of time, the fan 30 is interrupted again according to an instruction of the controller 50. While the fan 30 is re-operated, the interior air is introduced into the inside of the case 10 and the temperature sensor 40 detects the interior temperature from the interior air flowing into the case 10. As shown in the table 2, this action may be intermittently carried out at certain time intervals, which is pre-set in the controller 50. As the result of temperature detection, when the interior temperature is not between thee second and third pre-set temperature, the controller 50 operates the heat 20 and the fan 30 to thereby supply hot air into the interior of the room.

TABLE 2

| | | | | | | | | Off |
|---|---|---|---|---|---|---|---|---|
| | Fan On | Fan Off | Fan On | Fan Off | Fan On | Fan Off | Fan On | (restore) |
| After the | 2 min | 6 min | 25 sec | 12 min | 25 sec | 24 min | 25 sec | |
| heater is | 25 sec | | | | | | | |
| interrupted | | | | | | | | |
| and a | | | | | | | | |
| certain time | | | | | | | | |
| is passed | | | | | | | | |

For example, as shown in the table 2, after the operation of the heater 20 is interrupted and a certain period of time is passed, the fan 30 is operated in the same manner as in the table 1 and thus the temperature sensor 40 can carry out a precise measurement of the interior temperature. If the interior temperature does not remain between the second and third pre-set temperature, the controller 50 operates the heater 20 and the fan 30 to thereby supply hot air into the interior of the room. This course of action is repeatedly carried out by means of the controller 50. Therefore, the prevention of freeze-fracture of the water pipe or the like can be efficiently achieved. As shown in the tables 1 and 2, it can be understood that the re-operating times of the fan 30, which are pre-set in the controller 50, can be applied to the operating state and also the interruption period of operation.

The above course of actions occurs when the operation is interrupted (turned off). That is, if the interior temperature reaches a certain pre-set temperature, the operation is resumed while indicating the temperature and the operational status, thereby supplying hot air. Therefore, the freeze-rupture of the water pipe due to the prior art problems can be prevented. Since the hot air is intermittently supplied such that the interior temperature is maintained within a temperature range pre-set so as to have a temperature difference, the effect of power saving can be obtained. In addition, if the temperature is not lowered for a certain period of time, it comes to a turn-off state (the interrupted state of operation is restored).

### INDUSTRIAL APPLICABILITY

As described above, according to the present invention, at the state where the electric power is continuously supplied, the heater and the fan are intermittently operated in the operating state and also even at the interrupted state of operation. Therefore, the hot air can be efficiently supplied into the interior of a room to thereby prevent the freeze-rupture of the water pipe or the like. Accordingly, as compared with the conventional hot-air blower, which is operated over the whole wintertime to supply hot air, the electrical consumption can be considerably reduced, thereby providing a significant economical benefit. Furthermore, in the case where it is installed in the ceiling of the interior of a room, since the temperature of the interior of the room including the floor thereof can be precisely detected and hot air is supplied accordingly, the freeze-rupture of a water pipe installed in the floor can be prevented, dissimilar to the conventional technique.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A hot-air blower for supplying hot air in order to prevent freeze-rupture of a water pipe or the like, the hot-air blower being installed in the interior of a room, the hot-air blower comprising:
a) a case having a desired size of accommodation space, the case being installed in the ceiling or the wall of the interior of a room such that one side face thereof is exposed to the outside;
b) a heater installed inside the case and adapted to generate heat for prevention of freeze-rupture of the water pipe and the like;
c) a fan installed at the proximity of the heater inside the case, wherein, while the heater is operated, the fan forms an air circulation cycle passing the heater and the interior of the room to thereby supply hot-air into the interior of the room, and wherein the fan is re-operated independently to in-flow the interior air inside the case even after the operation of the heater is interrupted;
d) a temperature sensor installed inside the case and adapted to detect the temperature of the interior air flowing into the case through the fan, the detected temperature being used as data to determine whether or not the heater and the fan are to be operated;
e) a controller installed inside the case and adapted to form an electrical circuit with the heater, the fan, and the temperature sensor, wherein during the operation the controller controls the on/off operation of the heater and the fan according to the interior temperature detected by the temperature sensor, and wherein, the controller controls the post-interruption operation of the heater such that the temperature sensor detects the interior temperature and re-operation of the heater and the fan is carried out; and
f) a power supply installed inside the case and adapted to supply an electric power applied from outside to the heater, the fan, the temperature sensor, and the controller.

2. The hot-air blower according to claim 1, wherein during the operation the controller controls the operation of the heater and the fan such that the interior temperature detected by the temperature sensor is compared with a certain first pre-set temperature and the interior temperature is maintained equal to the first pre-set temperature, and wherein during the interruption of operation the controller controls the operation of the heater and the fan such that the interior temperature detected by the temperature sensor is compared with a second and third pre-set temperature established so as to have a temperature difference and the interior temperature remains between the second and third pre-set temperature.

3. The hot-air blower according to claim 1, wherein the controller controls the re-operation of the fan such that it is intermittently re-operated after the operation of the heater has been interrupted and a certain period of time has been passed.
